(19) United States
(12) Patent Application Publication
(10) Pub. No.: US 2005/0013428 A1
(43) Pub. Date: Jan. 20, 2005

(54) Contact center optimization program

(76) Inventor: James Frederick Walters JR., Charlotte, NC (US)

Correspondence Address: Adams Evans P.A.;2180 Two Wachovia Center, 301 S. Tryon Street, Charlotte, NC, 28282, US

(21) Appl. No.: 10/893,683

(22) Filed: Jul. 16, 2004

Related U.S. Application Data
(60) Provisional application No. 60/488,033, filed on Jul. 17, 2003.

(51) Int. Cl. H04M 3/00; H04M 5/00

(52) U.S. Cl. 379/266.08; 379/265.1

(57) ABSTRACT

A contact center performance optimization program for assisting contact center managers improve the performance of their centers comprises a hosted database that collects actual data and a modeling and optimization program that can be used to create center budgets and forecast future performance. The program facilitates improved contact center performance by providing analysis of current operations and forecasting through the use of models, optimization, analyzers and imbedded best practices. The inventive device includes. To forecast future performance and optimize the center's operation, “what if” models and analyzers are used. The invention includes a series of impact analyzers that assist the center manager focus on areas that if improved will produce the greatest overall performance improvement.

This application claims the benefit of U.S. Provisional Application No. 60/488,033, filed Jul. 17, 2003.

### TECHNICAL FIELD AND BACKGROUND OF THE INVENTION

This invention relates to a process for optimizing the performance of a contact center. The invention is particularly designed to assist in the management of customer service contact centers. The invention aids managers in determining the optimum parameters at which to operate the contact center, and provides guidance in the management of the center to maximize efficiency.

Customer service contact centers are a common and integral part of modern industry. Virtually every business that sells a product or service maintains a contact center for receiving calls from customers. Such contact centers serve a variety of important company functions, such as receiving and answering inquiries from potential customers, accepting and processing purchase orders, and providing technical support to existing customers. Communication between the contact center and the customers can take place in a variety ways, such as by telephone, facsimile and e-mail. Due to the critical functions typically performed by a contact center, the efficiency, accuracy, and reliability of the contact center's performance often has a significant relationship to a company's overall profitability. Furthermore, the many unpredictable variables that affect the operation of a contact center makes successful management difficult. For these reasons, a method for maximizing a contact center's efficiency is generally desirable.

Prior art contact center optimization tools exist in which a database stores and reports contact center metrics and information. A disadvantage of such conventional tools is that they are primarily developer tools and are difficult to use for those with relatively little training. As such, it takes substantial time to get started and gain value from the product. Another problem with conventional contact center optimization tools is that they do not address particular problems that are common to most centers. In addition, the current products do not have the capability to forecast probable outcomes of a variety of possible scenarios using hypothetical “what if” models that take into account different variables. Furthermore, conventional contact center optimization tools are designed primarily for large contact center operations and are not affordable by the small to medium size centers. Prior art work force impact programs do not consider financial factors and link them to operating efficiencies.

In view of the foregoing disadvantages inherent in the known types of contact center optimization tools now present in the prior art, the present invention was conceived.

### SUMMARY OF THE INVENTION

Therefore, it is an object of the invention to provide a contact center performance optimization application construction to assist contact center managers improve the performance of their centers. The present invention helps attain better contact center performance by providing improved analysis of current operations and creating improved budgets and forecasting through the use of models, optimization, analyzers and imbedded best practices.

Another object of the present invention is to provide a contact center performance optimization application that will overcome the shortcomings of the prior art devices described above.

Another object is to provide a contact center performance optimization application that can be easily learned, and can quickly assist contact center managers better understand the key drivers of performance in their centers and the ability to model changes in these drivers to improve their center's operation.

Yet another object is to provide a contact center performance optimization application that allows center managers create call center plans or budgets based from modeled data and comparisons with past actual performance.

Yet another object is to provide a contact center performance optimization application that assists center managers meet their budget and goals by providing short tern forecasts and comparing the forecast to their budget and goals. These forecast can be compared to the center's actual results for the period and through analytical comparisons the center manager will have better understand of the key areas that drove their centers performance against their plan and forecast.

Yet another object is to provide a contact center performance optimization process that will allow the center manager to analyze performance variables by using modeled “what if” scenarios that predict the impact a change in one or more of the variables will produce.

Yet another object is to provide a contact center performance optimization program that will provide detailed performance reports and graphical presentation of these results and comparisons.

Yet another object is to provide a contact center performance optimization program that will not require the installing of software on the customers computer servers or personal computers.

Yet another object is to provide a contact center performance optimization application that allows for the collection and storage of the most pertinent benchmark data elements and compares the particular center's performance against these key benchmark metrics.

These and other objects of the present invention are achieved in the preferred embodiments disclosed below by providing a program for optimizing the operation of a contact center including a database for collecting data relating to the operation of a contact center, and a modeling and optimization engine in communication with the database for forecasting future performance of the contact center based on the data collected in the database. The modeling and optimization engine determines a likely impact that a predetermined hypothetical change in the operation of the contact center will have on the future performance of the contact center by processing a series of hypothetical scenarios.

According to a preferred embodiment of the invention, the modeling and optimization engine determines an optimum operational parameter at which the contact center should operate to maximize efficiency of the contact center.

According to another preferred embodiment of the invention, the program includes at least one impact analyzer that contains data relating to an operational variable that impacts the performance of the contact center. The modeling and optimization engine processes the data contained in the impact analyzer to determine an optimum operational parameter at which the contact center should operate to maximize efficiency of the contact center.

According to yet another preferred embodiment of the invention, the operational variable is shrinkage, true calls, staff hiring, call transfers, first call resolution, productive time, staff seating, staff training, staff turnover, scheduling, revenue, overhead, benchmarks, or occupancy.

According to yet another preferred embodiment of the invention, the program includes a plurality of impact analyzers, and each impact analyzer contains data relating to an operational variable that impacts the performance of the contact center. The modeling and optimization program can predict how a change in one operational variable will effect another operational variable.

According to yet another preferred embodiment of the invention, the database includes a sub-database for storing data relating to the contact center, a sub-database for storing data relating to employees of the center, a sub-database for storing data relating to the operation of the center, and a sub-database for storing data relating to seating arrangements of the employees.

According to yet another preferred embodiment of the invention, the data relating to the contact center includes historical data relating to the past performance of the contact center.

According to yet another preferred embodiment of the invention, the modeling and optimization engine processes the historical data to predict the future performance of the contact center.

According to yet another preferred embodiment of the invention, the modeling and optimization provides a short-term and long-term prediction for future performance of the contact center.

According to yet another preferred embodiment of the invention, the modeling and optimization engine processes a series of hypothetical scenarios using the historical data to predict the likely impact that a predetermined hypothetical change in the management of the contact center will have on the future performance of the contact center.

According to yet another preferred embodiment of the invention, an extractor extracts data from a plurality of sources contained within the contact center.

According to yet another preferred embodiment of the invention, a work force management program creates schedules of employees of the contact center and tracking non-scheduled activities of the employees.

According to yet another preferred embodiment of the invention, a benchmark analyzer collects operational performance data relating to other contact centers.

According to yet another preferred embodiment of the invention, a reporting program for produces reports relating to the contact center.

According to yet another preferred embodiment of the invention, a performance analyzer provides reports showing current performance of the contact center in relation to one or more factors, such as service level performance, operating efficiency performance, and agent performance.

According to yet another preferred embodiment of the invention, the operating efficiency performance includes data relating to staff utilization, cost per call, cost per productive hour, and cost to produce a productive hour divided by staff salary per hour.

According to yet another preferred embodiment of the invention, the program includes a best practice library that stores data relating to preferred practices for operating contact centers.

According to yet another preferred embodiment of the invention, the program is based on an Internet code, and all analysis performed by the program is done through a web server.

According to yet another preferred embodiment of the invention, the program includes an on-line help component for assisting a user in operating the program.

A preferred method for optimizing the operation of a contact center according to the invention includes providing a database for collecting data relating to the operation of a contact center, and determining a likely impact that a predetermined hypothetical change in the operation of the contact center will have on the future performance of the contact center by processing a series of hypothetical scenarios. An optimum operational parameter is determined at which the contact center should operate to maximize efficiency of the contact center, and future performance of the contact center is forecasted based on the data collected in the database.

Another preferred method for optimizing the operation of a contact center according to the invention includes considering a plurality of operational variables that impact the performance of the contact center, and predicting how a change in one operational variable will effect another operational variable based on the data collected in the database.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic view of the major components of a contact center optimization program according to a preferred embodiment of the invention;

FIG. 2 is a schematic view of the center database of the contact center optimization program according to a preferred embodiment of the invention;

FIG. 3 is a schematic view showing the extractor of the contact center optimization program receiving data and storing it in center or agent databases,

FIG. 4 is a schematic view showing the interaction of the modeling and optimizer engines of the contact center optimization program according to a preferred embodiment of the invention;

FIG. 5 is schematic view showing the interaction of the reporting programs of the contact center optimization program according to a preferred embodiment of the invention;

FIG. 6 is a schematic view showing the impact analyzers of the contact center optimization program according to a preferred embodiment of the invention;

FIG. 7 is a schematic view showing the contents of the Best Practice Library of the contact center optimization program according to a preferred embodiment of the invention;

FIG. 8 is a schematic view of the Workforce Management programs of the contact center optimization program according to a preferred embodiment of the invention; and

FIG. 9 is a schematic view of the Performance Analyzers of the contact center optimization program according to a preferred embodiment of the invention.

### DESCRIPTION OF THE PREFERRED EMBODIMENT AND BEST MODE

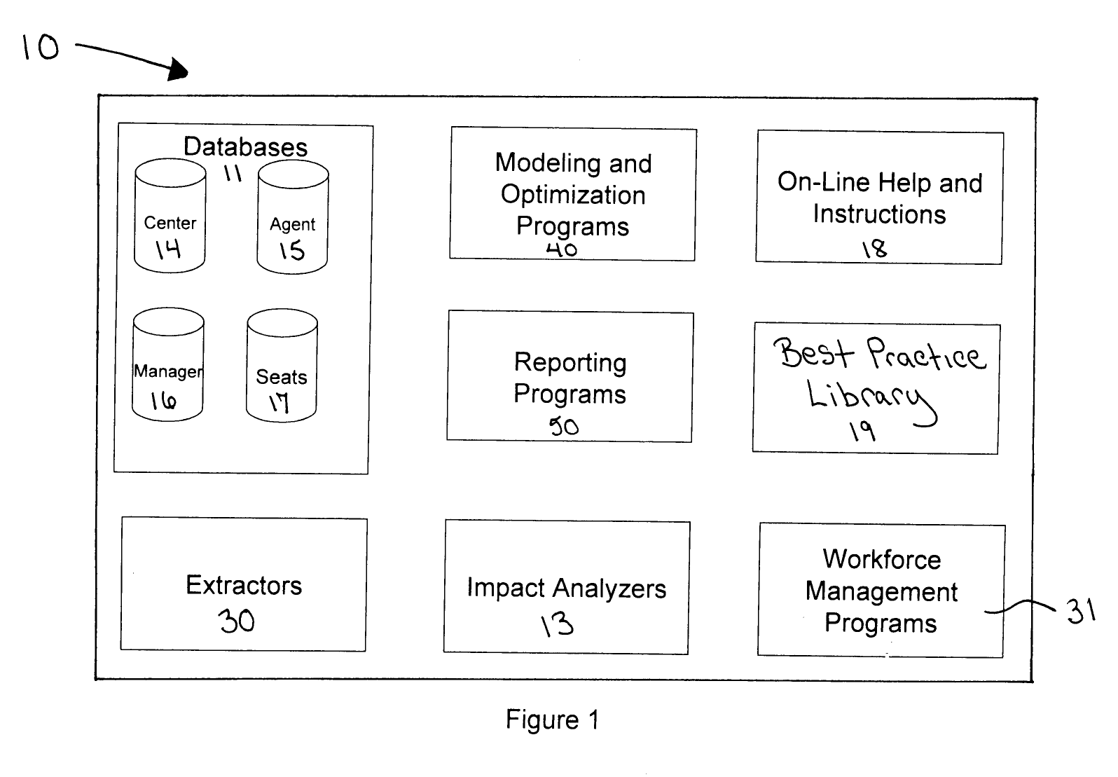

Referring now specifically to the drawings, FIG. 1 depicts the major components of a contact center performance optimization program according to a preferred embodiment of the invention. The contact center performance optimization program is designed for use by the manager of a contact center. A contact center can be any operation set up to receive telephone calls or other communications, such as a customer service center. The program, shown generally at reference numeral 10, comprises a hosted database 11 that collects actual data, and modeling and optimization programs 40 that can be used to create center budgets and forecast future performance of the contact center. To forecast future performance and optimize the centers operation, “what if” models and analyzers are used. A series of impact analyzers 13 assist the manager of the contact center to focus on areas that if improved will produce the greatest overall performance improvement.

Preferably, the program is based on an Internet code, such as java or html, so that the program can be run on an Internet webserver. As such, all computations and analysis performed by the program are done through the webserver, and all that is needed to use the program is a standard personal computer with an Internet web browser, such as MICROSOFT INTERNET EXPLORER.

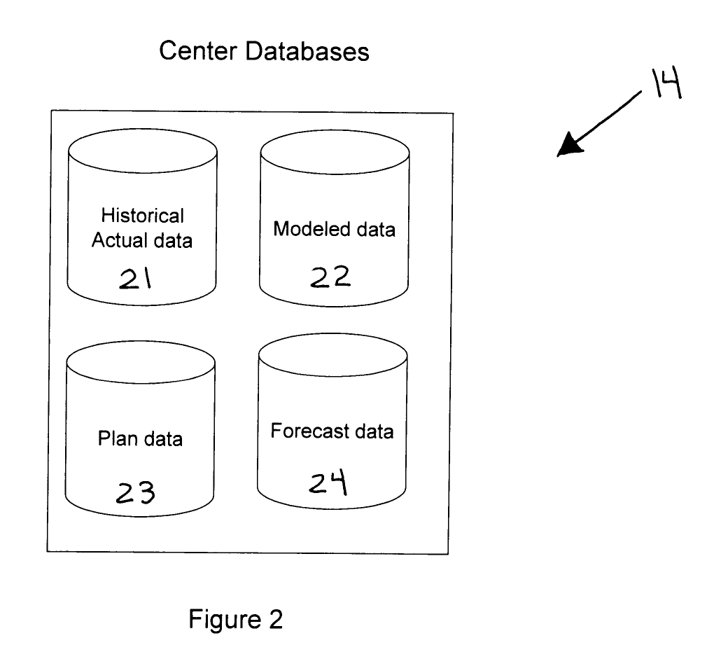

The database 11 of the program 10 includes four main interrelated sub databases: Center 14, Agent 15, Manager 16 and Seats 17, shown in FIG. 1. Information in the Center 14 is separated into one of four sub-databases: Historical 21, Modeled 22, Plan 23 or Forecast data 24, shown in FIG. 2. Historical data 21 is information relating to actual past performance of the contact center. Plan data 23 is information relating to the contact center's long term goals, and forecast data 24 is information regarding the contact center's short term objectives. Information is classified as modeled 22 prior to being grouped in either the plan 23 or forecast 24 database. The databases 21-24 relate agent and manager data to the centers organization structure and seating assignments.

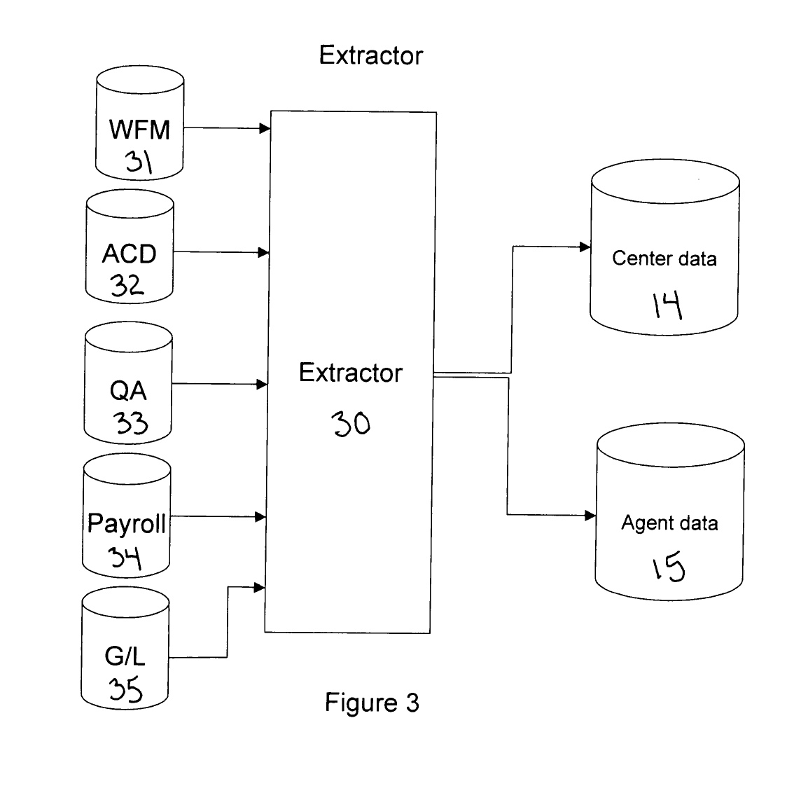

As shown in FIG. 3, an Extractor 30 extracts data from various systems, databases, applications or files of the contact center at a predetermined time and stores this data in the Center database 13 and Agent database 14. The information extracted by the extractor includes workforce management (WFM) 31, automated call distributor (ACD) 32, quality assurance (QA) 33, payroll 34, and general ledger (G/L) 35.

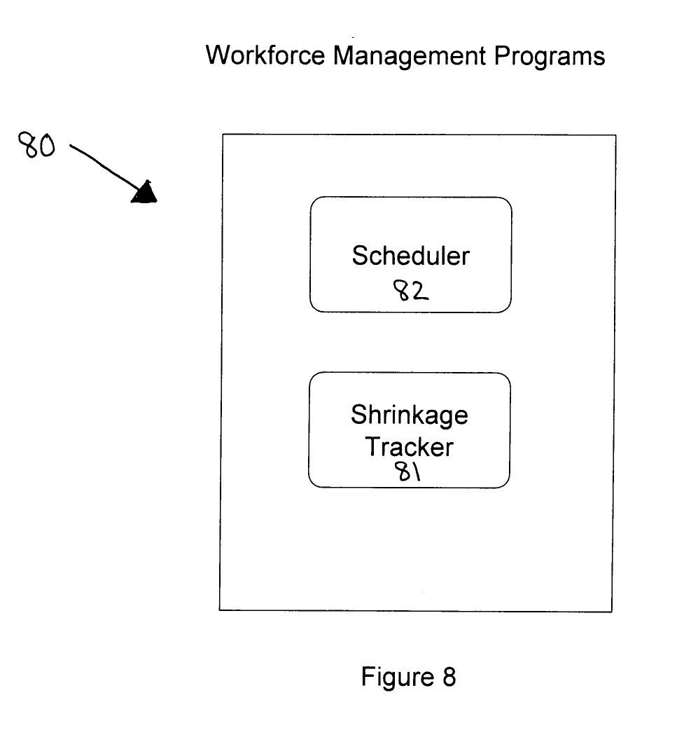

A workforce management program 80, shown in FIG. 8, assists the user in creating schedules and tracking non-scheduled activities. The workforce management program 80 provides analytical support to assist center staff establish work schedules and manage non-scheduled activity. The shrinkage tracker 81 collects information relating to the time an agent in a center spends in non-productive activity, and the scheduler 82 collects information regarding staff scheduling. The detail data comes from actual historical information drawn from other applications or from modeling future data and storing the modeled data 22 as a plan or forecast. The workforce management program 80 determines how much staff is needed at certain days and times.

The Extractor 30 receives information and stores it in the Center database 13 or Agent database 14. Information relating to the operation of the contact center is stored in the Manager database 15, and information relating to the seating of center workers, such as the number of seats and seat sharing, is stored in the Seats database 16.

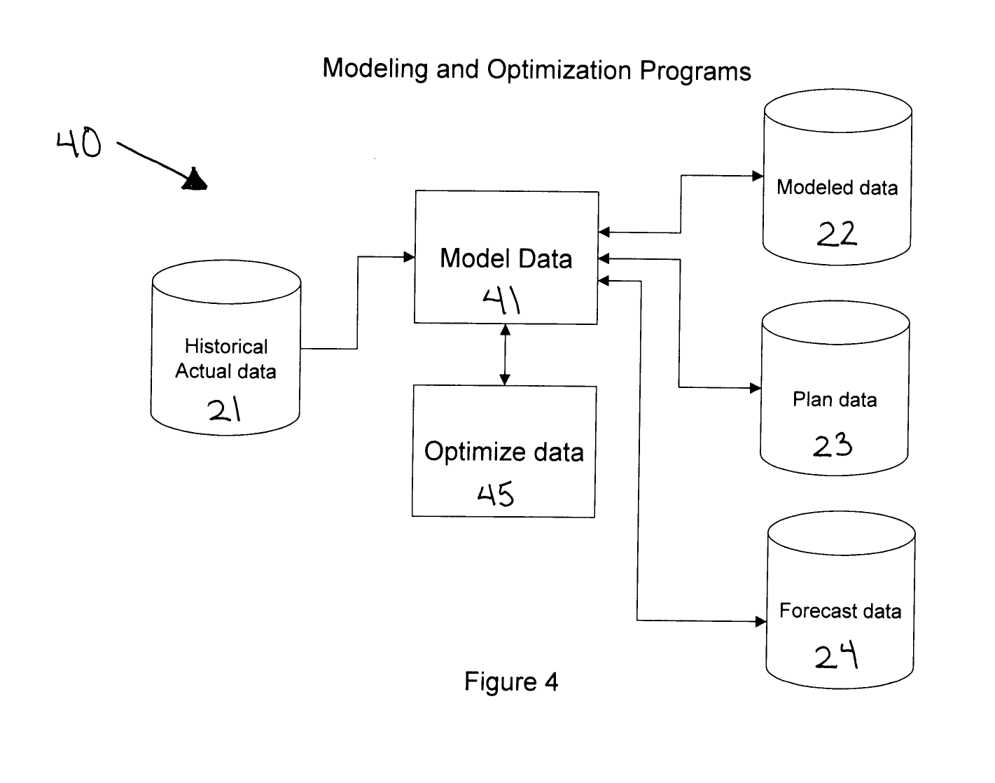

All data is entered into a Modeling and Optimization Engine 40, shown in FIG. 4, which comprises a Modeling Engine 41 and Optimization Engine 45. Historical data 21 obtained from the actual past performance of the contact center can be altered and additional information can be added by manual input of the user, as shown in FIG. 4. The Modeling Engine 41 analyzes all of the data and provides information regarding the likely short-term and long-term future performance of the contact center based on the information provided. The likely short-term future performance is the Forecast data 24, and the likely long-term future performance is referred to as Plan data 23. As such, the Modeling Engine 41 can assist managers in preparing the necessary budget for the next year. In addition, the Modeling Engine 41 can predict alternative outcomes by processing a series of hypothetical “what if” scenarios. For example, the user can perform a “what if” analysis to see the what the result on overall center performance and profitability would be if the number of employees was increased. Multiple operating variables can be altered and considered to determine likely outcomes in the form of Modeled data 22. The Modeling Engine 41 shares data with an Optimization Engine 45, which analyzes multiple variables to determine the optimum operating parameters for achieving the best overall performance of the center. The Optimization Engine 45 allows for manual or automated manipulation of key performance drivers to determine the optimum performance metrics across a series of key performance variables.

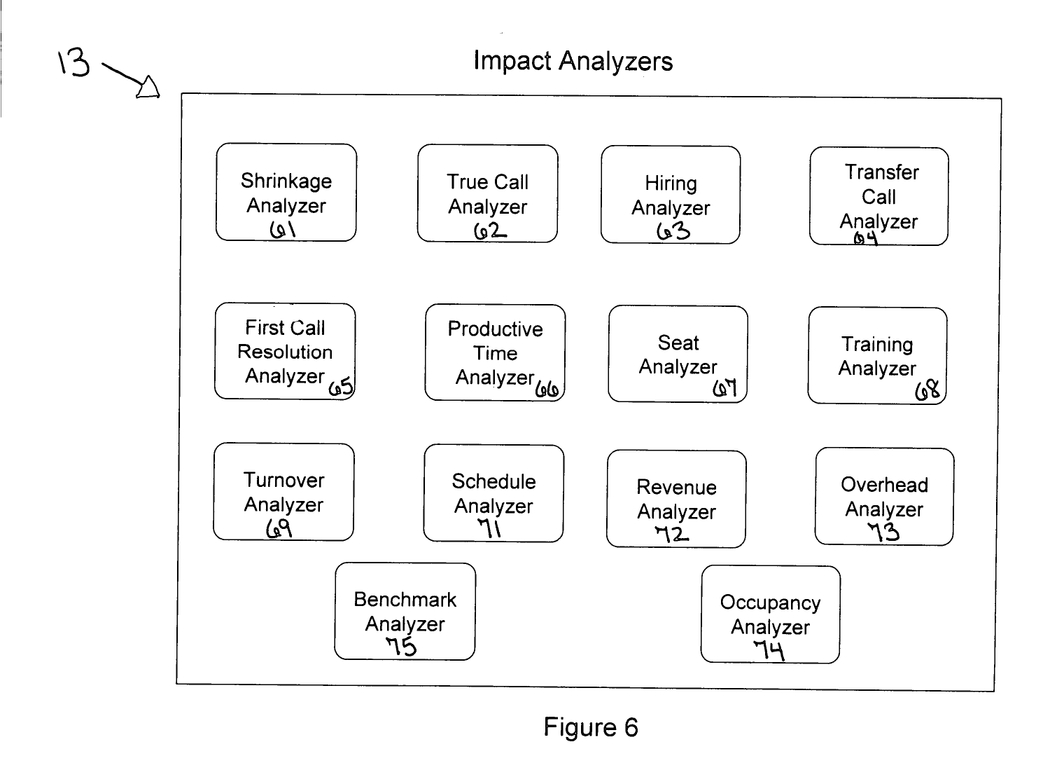

FIG. 6 shows fourteen variables that typically impact the operation and performance of a contact center, referred to as impact analyzers 13, that can be considered by the Modeling and Optimization Engines 40. Based on the data received, the Optimization Engine 45 can determine the optimum parameters at which certain variables measured by the impact analyzers 13 should operate to achieve the desired center performance.

For example, the Shrinkage Analyzer 61 measures unproductive time spent by center staff. The Shrinkage Analyzer 61 allows for the analysis of the detail elements of “shrinkage” and the impact that changes in shrinkage would have on production capacity and center staffing and labor cost. The Optimization Engine 45 can predict the impact a change in shrinkage will have on overall center performance.

The True Call Analyzer 62 collects and analyzes information over a period of time related to calls made to the center, calls abandoned before answered and answered or handled calls. As such, the True Call Analyzer 62 determines the true number of calls to help determine staffing needs.

The Hiring Analyzer 63 collects and analyzes information related to staff hiring, attrition and training. The Transfer Call Analyzer 64 collects and analyzes information related to calls transferred to other agents within the center or to other centers. This helps determine the frequency and cost associated with call transfers.

The First Call Resolution Analyzer 65 collects and analyzes information related to customer requests handled during the first call versus customers calling back, because the customers issue was not resolved on the first call. This measures the cost of not handling a call correctly the first time.

The Productive Time Analyzer 66 collects and analyzes the detail data elements comprising the time that agents spend performing productive work. The Seat analyzer 67 measures the number of seats for center operators, and considers operators sharing seats.

The Training Analyzer 68 collects and analyzes information relating to the time and cost of training new and existing center staff. The Turnover Analyzer 69 collects and analyzes information related to staff turnover.

The Schedule Analyzer 71 collects and analyzes information related to the efficiency of work schedules in the center. The Revenue Analyzer 72 collects data relating to revenue.

The Overhead Analyzer 73 collects and analyzes information related to center overhead staff expenses. The Occupancy Analyzer 74 collects data regarding the time an agent spends with a customer.

The Benchmark Analyzer 75 collects detail operational performance data from other centers and groups this data based on certain criteria. This data can then be compared to the data in the center database and analytical comparisons made. The data for the benchmark analyzer 75 can be imported from an Internet portal, or it can be created by the user from peer information.

The Optimization Engine 45 can utilize all of the above described Impact Analyzers 13 to help the user develop an operational plan for the contact center, and forecast the probable result of changes to one or more variables. In addition, the Optimization Engine 45 can predict how altering one variable in the center's operation will effect others. For example, by keeping all other variables constant, the Optimization Engine 45 can determine the amount of decrease in the turnover rate of center staff that will likely result from a predetermined increase in bonuses and incentives, by considering data from the Turnover analyzer 69 and Agent analyzer. Likewise, it can be determined the effect such changes would have on shrinkage and productive time, or any of the other variables measured by the Impact Analyzers 13. As such, the program 10 assists contact center managers in virtually every aspect of contact center management. For instance, when a manager is considering making a change in the number of employees, the program 10 can forecast the effect an increase or decrease in staff will have on other aspects of the operation, such as training and overhead costs, and the overall center performance.

The Impact Analyzers 13 allow the user to measure and model the impact of the user's management decisions on the efficiency of the contact center, and predict the likely impact of hypothetical scenarios. Using the data stored in the Impact Analyzers 13, a determination can be made of the likely impact that a certain change in the management of the contact center would have on the efficiency of the contact center.

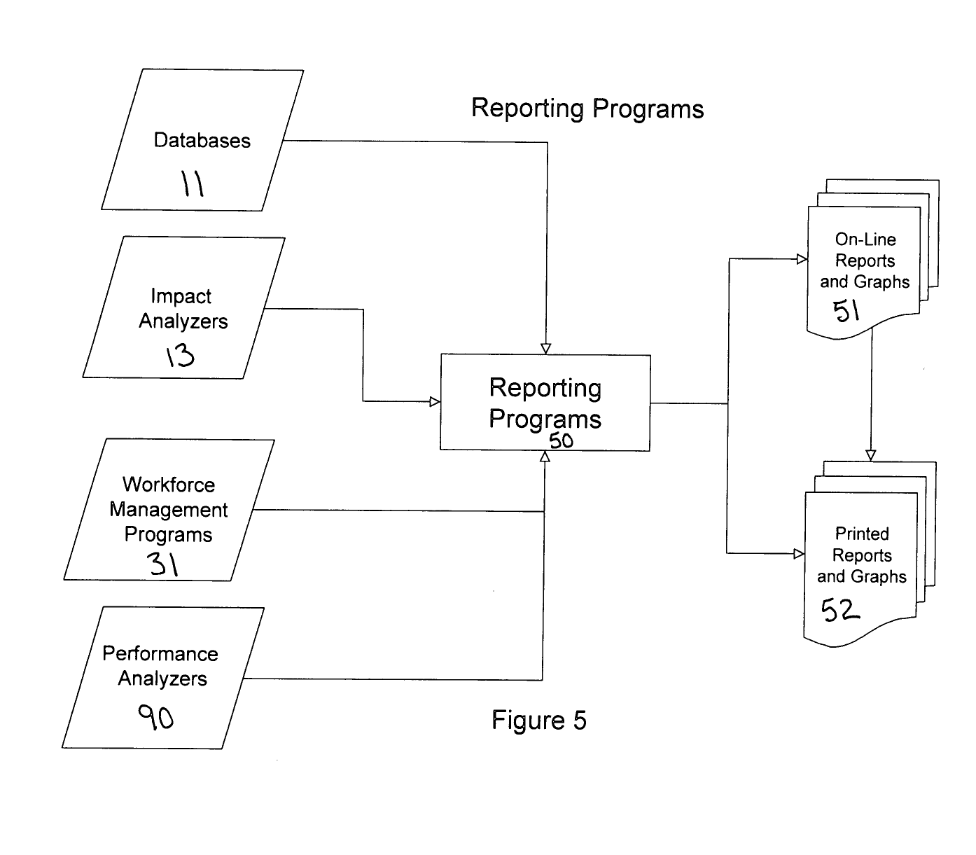

The contact center optimization program 10 includes a Reporting Program component 50 that provides for on-line viewable reports and graphs as well as the ability to print these reports. As shown in FIG. 5, the Reporting Program 50 pulls data from various databases and programs and presents this information as online reports 51 in text and graphical formats, and printed reports and graphs 52.

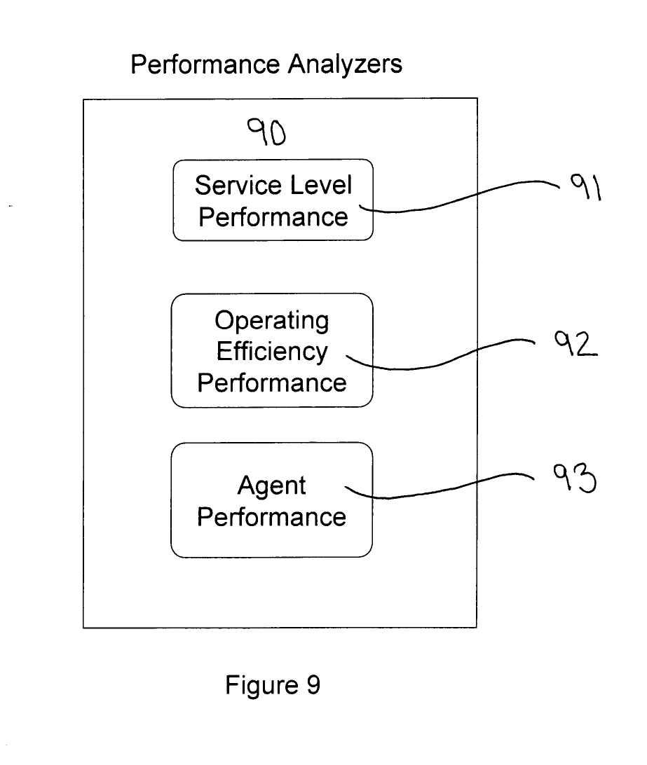

Among the programs used by Reporting Program 50, is Performance Analyzers 90. The Performance Analyzers 90, shown in FIG. 9, produce reports and graphs based on past performance data that show how the center is performing in relation to several key factors: Service Level Performance 91, Operating Efficiency Performance 92 and Agent Performance 93. Service Level Performance 91 shows how the contact center is performing in relation to certain predetermined goals, such as accuracy of forecast of call volume, time per call, average speed of answer and answer/abandonment rate. The data is measured on a daily, weekly and monthly basis. Operating Efficiency Performance 92 compiles data relating to staff utilization, cost per call, cost per productive hour and the efficiency ratio. The efficiency ratio is the cost to produce a productive hour divided by the staff salary per hour. Agent Performance 93 measures the agents of the contact center in relation to peers and identifies outliers. Outliers are agents who are either underperforming or over performing in relation to other agents. This enables the user to investigate the particular agents to determine the reason for his or her outlying performance.

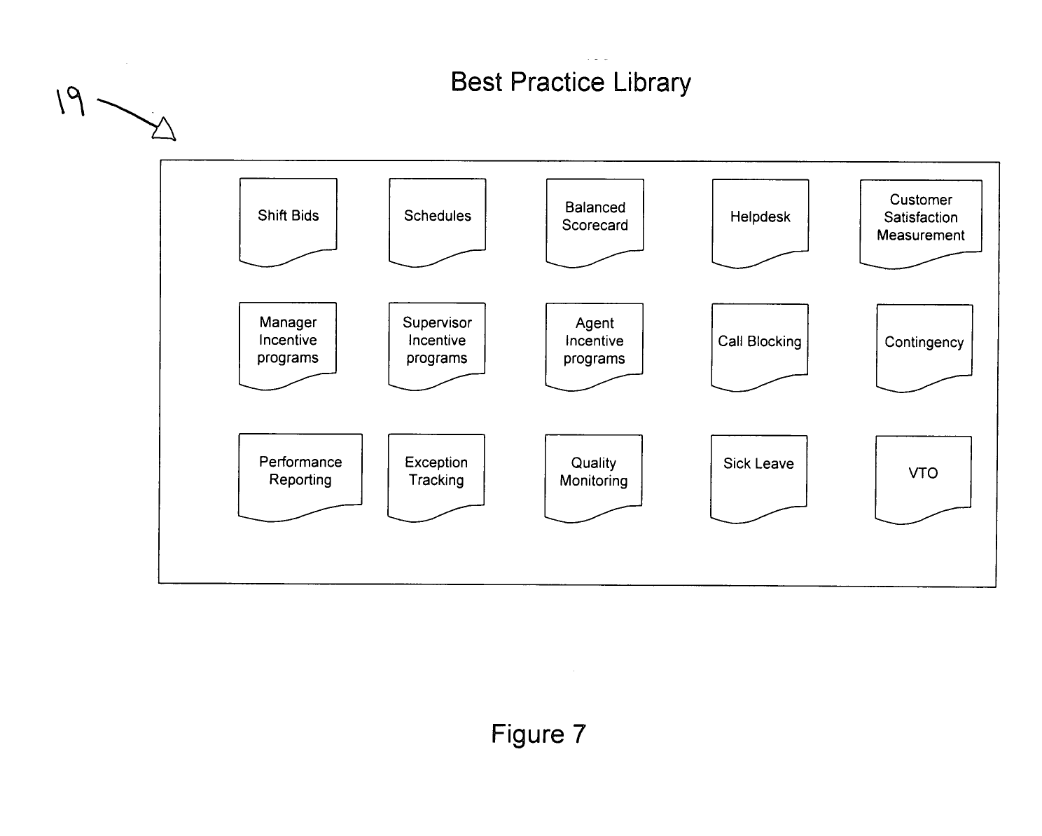

The contact center optimization program 10 includes a Best Practice Library 19, shown in FIGS. 1 and 7, that stores a database of proven contact center best practices relating to a variety of subjects that are common to contact centers. For example, the Library contains information on shift bids, in which employees bid on preferred schedules. Balanced scorecard refers to key performance measures. Call blocking discusses how to handle unwanted calls, and “VTO” refers to voluntary time off.

An On-Line Help and Instructions component 18, shown in FIG. 1, assists the user in getting help with operating the various programs, and provides a glossary of relevant terms and definitions. The On-Line Help and Instructions 18 provides field level help and instructions on the operating of particular programs and functions. Access to the information can come through keyword search or by topic or subjects.

In order to run a contact center efficiently and effectively, a contact center manager is required to balance a number of conflicting variables such as satisfactory customer service levels, expense management, agent performance, etc. The contact center optimization program 10 of the present invention is designed to help a contact center manager balance these variables and attain an optimal level of performance. The following is a description of a preferred method for using the program 10.

The contact center manager will first use the Extractor 30 to enter up to twelve months of historical data 21 into the center database 14. To understand how the center's key performance variables may change over time due to the cyclical nature of the business or other factors causing changes from month to month, the center manager will use the reporting program to produce a trend report and graph.

Next, the manager is ready to create a plan or budget for the upcoming fiscal year. To do this, the Modeling Engine 41 is used to project and enter the key performance variables for the twelve month budget. This budget will take into account variations in the key performance variables based on cyclical trends, business plans or other factors that should be considered during this period of time. As the manager is developing the budget, the Modeling Engine 41 is used to establish the most likely performance scenario that accomplishes the desired results. Once the desired budget is completed, the results will be saved into the center database as a named file indicating this information is the budget for some specified period.

If the manager is unsure of the best or optimum balance between the performance variables, the manager can use the automated Optimization Engine 45. This program will analyze the historical data 21. Using the managers projected budget data, the Optimization Engine 45 will develop a set of production variables that results in the optimal center performance.

Most budgets are created well in advance of the time period. For instance, budgets for the calendar year of 2004 might be created as early as June or July of 2003. Therefore, the key variable that drives the budget results may be projected as far out as eighteen months (in June 2003 a budget for December 2004 will be created). To determine how close you will be to your budget as the year progresses, a forecast is developed. Using the Modeling Engine 41, the manager will create a 3-6 month forecast that best represents the center's most recent performance and incorporates any known impacts based on business changes or other factors that were not taken into account when the budget was created. This forecast can be created by using the Modeling Engine 41 and loading either recent historical information and modifying it or loading the budget information for that period and modeling it to create the forecast 43. Once the desired forecast 43 is completed, the results will be saved in the Center Database 14 as a named file indicating this information is the forecast 43 for some specified period.

Using the Reporting Program's 50 comparison function, several sets of data in the Center Database 14 will be compared. First, when a historical period is completed—the most recent month's center performance data is available. This data can be compared to the budget and forecast 43. When a forecast 43 is created, it can be compared to a recent historical period or to the budget for this period.

The Impact Analyzers 13 are used to help understand the impact certain key performance drivers have on the center's actual performance. These can be used as an analytical tool to show cause and effect when comparing the results from one month to the next, the differences in results between actual historical results and budget, actual results and forecast or forecast to budget. Using these Impact Analyzers 13 and the Modeling Engine 41, the impact on performance can be determined by changes in key variables within the Impact Analyzers 13.

For example, using the Reporting Program's 50 comparison feature, the manager discovers that the center did not meet the budget for a particular period in two key areas. By using the Reporting Program's 50 focused view, the manager discovers this particular period was impacted by a decrease in staff shrinkage creating higher than required service levels and a lower than forecasted occupancy. Using the Modeling Engine 41, the impact on personnel cost and staffing levels can be determined.

Now the manager wants to know why there was this difference and what could have been done to adjust for these changes in the center that were not anticipated. To do this, the manager will load the Shrinkage Analyzer 61 and have the Extractor 30 enter the historical actual shrinkage data 21. Using the Reporting Program 50 the actual data 21 will be compared to the forecast 24 and budget. In this example, the manager discovers that the training budgeted and forecasted for this month was delayed to next month resulting in excess staff being available.

The manager wants to know what he can do next time this happens so he researches in the Best Practice Library 19 and discovers a practice called VTO—voluntary time off. Using the process instructions and forms included in the Best Practice Library 19 for VTO, the manager installs this procedure in the center to assist in handling this type of situation in the future.

Now that the manager and center staff understands the concept of VTO they will begin to forecast VTO using the Modeling Engine 41 and updating future Forecast data 24. The impact of using VTO in the center can be evaluated by using the Comparison—Reporting Program 50 and comparing the Budget against the new Forecast data 24.

In another example, the manager suspects the contact center's cost per call is high, but is unsure why. First, the manager accesses the Benchmark Analyzer 75 to see the center's cost per call compared to other centers' cost per call. If the contact center's cost per call is actually high in comparison to other centers, the manager accesses the Shrinkage Analyzer 61 to determine what can be changed to improve. The Shrinkage Analyzer 61 receives data relating to various types of shrinkage, such as benefit shrinkage, operational shrinkage, and daily shrinkage. Benefit shrinkage refers to vacation, sick leave and other kinds of staff absences. Operational shrinkage refers time employees are away from the job for training, meetings and other activities that are controllable by the manager. Daily shrinkage includes breaks, lunches and adherence (time allowed for employees to leave their desks for activities such as going to the restroom).

The manager inputs all of the above shrinkage data and the wages per hour for all employees. The Shrinkage Analyzer 61 provides a shrinkage percentage, which is the percentage of staff salary that is consumed by non-productive activities. For example, the shrinkage percentage may be 30%, meaning that 30% of staff salaries is spent on non-productive activities in which the employees are away from their normal duties.

The manager decides he wants to reduce the shrinkage percentage, but is not sure of the best way to do so. The manager enters a hypothetical change, such as reducing the amount of vacation time allotted to employees by a certain amount. While such a change will reduce shrinkage, the time spent my employees away from job duties, it may also have a negative impact by increasing the turnover rate of center employees as a reduction in vacation time is likely to result in some employees being less satisfied and ultimately terminating their employment. Accordingly, the manager accesses the Turnover Analyzer 69 to determine the likely effect of reducing vacation time by a certain amount. By accessing the Shrinkage Analyzer 61 and the Turnover Analyzer 69, the program 10 enables the manager to determine an optimum value ( the amount of reduction in vacation time) at which the reduction in shrinkage yields a greater reduction to the center's cost per call than increase to the cost per call resulting from the increase in turnover rate that is caused by the reduction in vacation time. As such, program 10 determines the best means for obtaining the lowest possible cost per call, and maximizes the efficiency of the contact center.

Alternatively, the manager may consider reducing the amount of time that employees spend in training and meetings in order to reduce shrinkage. While such a change will reduce shrinkage, it may also have a negative impact by reducing the competence in employees thus resulting in a decrease in the number of customer questions/complaints that are successfully resolved in the first call by the customer. If employees have less training, they are less likely to be able to handle a customer's question or concern effectively on the first call. Accordingly, the manager accesses the First Call Resolution Analyzer 65 to determine the likely impact that a proposed reduction in staff training will have on First Call Resolution. By accessing the Shrinkage Analyzer 61 and the Turnover Analyzer 69, the program 10 enables the manager to determine an optimum value (the amount of reduction in training time) at which the reduction in shrinkage yields a greater increase in center efficiency than the decrease that would be caused by the decrease in first call resolution resulting from the reduction training time.

While the examples above illustrate the use of two impact analyzers 13 to arrive at an optimum course of action for managing the contact center, there is no limit to the number of impact analyzers 13 that can be used when considering a particular course of action for the contact center. Preferably, all impact analyzers 13 maintain a database of relevant information that is simultaneously accessed and processed by the program 10 to arrive at an optimum change or action to maximize efficiency of the contact center.

A Contact Center Optimization Program and method for using same are described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. A program for optimizing the operation of a contact center comprising:
(a) a database for collecting data relating to the operation of a contact center;
(b) a modeling and optimization engine in communication with the database for forecasting future performance of the contact center based on the data collected in the database, wherein the modeling and optimization engine determines a likely impact that a predetermined hypothetical change in the operation of the contact center will have on the future performance of the contact center by processing a series of hypothetical scenarios.

2. A program according to claim 1, wherein the modeling and optimization engine determines an optimum operational parameter at which the contact center should operate to maximize efficiency of the contact center.

3. A program according to claim 1, and further comprising at least one impact analyzer for containing data relating to an operational variable that impacts the performance of the contact center, wherein the modeling and optimization engine processes the data contained in the impact analyzer to determine an optimum operational parameter at which the contact center should operate to maximize efficiency of the contact center.

4. A program according to claim 3, wherein the operational variable is selected from the group consisting of shrinkage, true calls, staff hiring, call transfers, first call resolution, productive time, staff seating, staff training, staff turnover, scheduling, revenue, overhead, benchmarks, and occupancy.

5. A program according to claim 1, and further comprising a plurality of impact analyzers, each impact analyzer containing data relating to an operational variable that impacts the performance of the contact center, wherein the modeling and optimization program can predict how a change in one operational variable will effect another operational variable.

6. A program according to claim 1, wherein the database comprises:
(a) a sub-database for storing data relating to the contact center;
(b) a sub-database for storing data relating to employees of the center;
(c) a sub-database for storing data relating to the operation of the center; and
(d) a sub-database for storing data relating to seating arrangements of the employees.

7. A program according to claim 6, wherein the data relating to the contact center includes historical data relating to the past performance of the contact center.

8. A program according to claim 7, wherein the modeling and optimization engine processes the historical data to predict the future performance of the contact center.

9. A program according to claim 8, wherein the modeling and optimization provides a short-term and long-term prediction for future performance of the contact center.

10. A program according to claim 7, wherein the modeling and optimization engine processes a series of hypothetical scenarios using the historical data to predict the likely impact that a predetermined hypothetical change in the management of the contact center will have on the future performance of the contact center.

11. A according to claim 1, further comprising an extractor for extracting data from a plurality of sources contained within the contact center.

12. A program according to claim 1, further comprising a work force management program for creating schedules of employees of the contact center and tracking non-scheduled activities of the employees.

13. A program according to claim 1, further comprising a benchmark analyzer for collecting operational performance data relating to other contact centers.

14. A program according to claim 1, further comprising a reporting program for producing reports relating to the contact center.

15. A program according to claim 1, further comprising a performance analyzer for providing reports showing current performance of the contact center in relation to one or more factors selected from the group consisting of service level performance, operating efficiency performance, and agent performance.

16. A program according to claim 15, wherein operating efficiency performance comprises data relating to staff utilization, cost per call, cost per productive hour, and cost to produce a productive hour divided by staff salary per hour.

17. A program according to claim 1, further comprising a best practice library for storing data relating to preferred practices for operating contact centers.

18. A program according to claim 1, wherein the program is based on an Internet code, and all analysis performed by the program is done through a webserver.

19. A program according to claim 18, further comprising an on-line help component for assisting a user in operating the program.

20. A method for optimizing the operation of a contact center comprising the steps of:
(a) providing a database for collecting data relating to the operation of a contact center;
(b) determining a likely impact that a predetermined hypothetical change in the operation of the contact center will have on the future performance of the contact center by processing a series of hypothetical scenarios;
(c) determining an optimum operational parameter at which the contact center should operate to maximize efficiency of the contact center; and
(d) forecasting future performance of the contact center based on the data collected in the database.

21. A method according to claim 21, further comprising the steps of:
(a) considering a plurality of operational variables that impact the performance of the contact center; and
(b) predicting how a change in one operational variable will effect another operational variable based on the data collected in the database.
